(19) United States
(12) Patent Application Publication
(10) Pub. No.: US 2026/0145822 A1
(43) Pub. Date: May 28, 2026

(54) Multi-purpose unmanned combat drone

(71) Applicant: Yerlan Alimkhanov, Rockville, MD (US)

(72) Inventor: Yerlan Alimkhanov, Rockville, MD (US)

(21) Appl. No.: 18/958,818

(22) Filed: Nov. 25, 2024

(51) Int. Cl. B64U 20/70; B64U 10/14; B64U 20/50; B64U 20/80; B64U 30/293; B64U 50/31; B64U 101/18

(52) U.S. Cl. CPC B64U 20/70; B64U 10/14; B64U 20/50; B64U 20/80; B64U 30/293; B64U 50/31; B64U 2101/18; B64U 2201/20

(57) ABSTRACT

A multi-purpose combat unmanned drone is presented, designed to perform an unlimited number of operations in the air and on the ground. In order to ensure the performance of multiple tasks, the multi-purpose unmanned combat drone is equipped with a central longitudinal tubular frame, at the ends of which the head and tail parts are evenly placed, including all the flight equipment, as well as beams located transversely or at an angle to the longitudinal frame, at the ends of which the rotors are located. Depending on the type of task, the drone operator alternately installs one or another quick-change module on the drone frame. The number of modules is unlimited. The drone can also have the simplified longitudinal tubular frame, with the rotors at both ends, without transverse beams. The multi-purpose combat unmanned drone is equipped with a telemetry system, one or more video cameras for all-round visibility, with the help of which the operator remotely controls the flight, searches for targets, aims, fires, or controls the module. The drone can also be controlled using satellite navigation, internet connection, or with a programmed algorithm for flying and performing tasks.

### CROSS-REFERENCE TO RELATED APPLICATIONS

This Application claims priority to U.S. Provisional Patent Application Ser. No. 63/567,911, filed on Mar. 20, 2024, to Yerlan Alimkhanov entitled “Multi-purpose unmanned aerial combat drone” currently pending, the entire disclosure of which is incorporated herein by reference.

This Application claims priority to U.S. Provisional Patent Application Ser. No. 63/454,458 filed on Mar. 24, 2023, to Yerlan Alimkhanov entitled “MULTI-PURPOSE UNMANNED AERIAL COMBAT DRONE” currently expired, the entire disclosure of which is incorporated herein by reference.

This application is continuation-in-part of U.S. Provisional Patent Application Ser. No. 63/347,471 filed May 31, 2022, to Yerlan Alimkhanov entitled “Unmanned aerial grenade launcher” the entire disclosure of which is hereby incorporated herein by reference.

This application is continuation-in-part of U.S. Provisional Patent Application Ser. No. 63/345,418 filed May 24, 2022, Yerlan Alimkhanov, to entitled “Unmanned aerial grenade launcher” the entire disclosure of which is hereby incorporated herein by reference.

### FIELD OF THE INVENTION

The invention mainly relates to defense systems, specifically it is a multi-purpose combat unmanned aerial vehicle-platform capable of carrying and attacking various types of weapons. Also, its design includes functions for its wide application in the logistics, civil, industrial and emergency services sectors.

### BACKGROUND OF THE INVENTION

Modern wars demonstrate the highest efficiency of multicopter drones. In fact, they have changed the tactics and strategy of warfare. Thus, the war in Ukraine has proven that cheap, low-visibility quadcopter drones are capable of destroying almost any expensive armored enemy vehicles, tanks, armored personnel carriers, infantry fighting vehicles, multiple rocket launchers, various fortified shelters, dugouts and even helicopters and low-flying aircraft. Drones have also proven their effectiveness in naval operations, hitting even enemy ships and floating craft.

But, hitting the target, the kamikaze drone itself dies.

Existing mid-sized drones carrying grenade launchers and capable of firing at a distance have a limited amplitude of barrel tilt, since they turn to the angle of attack due to the tilt of the drone itself, or using a mechanism with a limited angle of tilt. Therefore, existing drones are not yet so effective in combating low-flying and ground targets.

For example, cheap low-flying glider-type drones-shaheeds with a moped engine have recently. appeared. They attack the civilian population of Ukraine in dozens and hundreds every day.

To destroy such very dangerous drones, many expensive missiles, anti-aircraft installations, millions of large-caliber cartridges and extremely expensive air defense are required. This is very expensive for any country.

Therefore, air defense is in dire need of cheap drones that can fly as close as possible to low-flying air targets and destroy them with rocket-propelled cluster grenades and missiles with scattered striking elements that explode at least near the flying enemy drone and hit it with shrapnel.

But such a drone will be highly specialized and will be unsuitable for performing other important tasks. Modern warfare requires drones to perform unlimited types of tasks, such as fire attacks, bombing, reconnaissance operations, logistics, providing troops with ammunition, medicine, electricity for recharging radio stations and much more.

Therefore, now, the troops have many multicopter drones of the same class, but from different brands and manufacturers.

They perform approximately similar tasks, but, as a rule, have different spare parts.

In combat conditions, drones get knocked down, get into accidents, fall, break down and they are in dire need of quick field repair, spare parts and their interchangeability. The lack of spare parts for a particular drone model leads to its unsuitability.

A military unit must be able to take a spare part from one drone and quickly put it on another drone to complete a combat mission.

The use of a universal drone will have a positive effect on the cost of operations in any area.

Therefore, the objective of the proposed invention is to create a multi-purpose universal drone platform, which, depending on the situation, can be a combat drone, firing various weapons in any direction in space at 360 degrees, or quickly, within a few minutes, transform into a transport and logistics drone, a fire drone and much more, while maintaining the same basic design that satisfies different consumers.

### BRIEF SUMMARY OF THE INVENTION

The present invention is a multi-purpose flying platform related to the field of unmanned multi-copter combat drones. The main purpose of the multi-purpose drone is military, but it can also perform various functions in the civil and industrial spheres and in the emergency situation services.

This application discloses two embodiments of the multi-purpose unmanned combat drone. The first embodiment is a four-rotor multi-purpose unmanned combat drone with the H-shaped frame and the second embodiments of the multi-purpose unmanned combat drone is a two-rotor drone platform with the I-shaped frame. The multi-purpose unmanned combat drone can have a different number of the rotors.

Ordinary existing multi-copter drones have a spider-like shape and all their equipment is located in the central body. Despite its compactness, such a drone has a limited number of useful functions, as well as a limited number of degrees of freedom of the suspended devices aggregated with it.

The multifunctionality of the proposed drone is achieved due to the fact that it is equipped with a special longitudinal frame and various modules. The modules can be changed and individually docked to the drone frame.

This frame also acts as an axis for installing rotating modules on it. The main equipment and batteries that ensure the flight of the drone are located at the ends of the frame, which allows for an even distribution of the drone's center of mass and the placement of various useful modules in the center of the drone frame.

For example, to fire a grenade launcher, the operator attaches a module with grenade launcher barrels to the drone and sends the drone to fire at various targets from a distance of up to 2 km. After firing, the drone returns to the base and the operator removes the used module with grenade launchers and attaches another, cargo module to the drone, for example, to deliver medicines to the battlefield. If necessary, he changes the drone's batteries and sends the drone on this mission. And so on. The number of modules, and therefore the number of operations performed, can be unlimited.

Therefore, the drone is multipurpose. The main replaceable modules of the drone-multicopter can be a grenade launcher, a rocket launcher, a module with small arms, modules for transporting and dropping hand grenades, mortar mines, bombs, cruise missiles, corrected and diving ammunition, a module with a laser gun, a flamethrower, a water cannon, various smoke bombs and heat bombs—false targets. In addition, a module is provided—a folding solar power plant, as well as modules for transporting cargo and much more. The types of modules can be unlimited, then in this description.

This versatility allows one drone to be used to perform an unlimited number of tasks instead of a dozen other drones each performing a specific task.

### DESCRIPTION OF THE SEVERAL VIEWS OF THE DRAWING

FIG. 1 is a side view of the multi-purpose unmanned aerial vehicle without the docking module in accordance with one embodiment of the present invention;

FIG. 2 is a top view of the multi-purpose unmanned aerial vehicle without the docking module in accordance with one embodiment of the present invention;

FIG. 3 is a side view of the multi-purpose unmanned aerial vehicle with the docked module for dropping hand grenades;

FIG. 4 is a top view of the multi-purpose unmanned aerial vehicle with the docked module for dropping hand grenades;

FIG. 5 is a front view of the docked module for dropping hand grenades in section;

FIG. 6. is a side view of the multi-purpose unmanned aerial vehicle with the docked module for dropping mortar mines;

FIG. 7 is a front view of the docked module for dropping mortar mines in section;

FIG. 8. is a side view of the multi-purpose unmanned aerial vehicle with a docked module for dropping different type of bombs;

FIG. 9. is a side view of the multi-purpose unmanned aerial vehicle with the docked module for dropping self-propelled rocket;

FIG. 10. is a top view of the multi-purpose unmanned aerial vehicle with the docked module for launching winged bomb or glider drone;

FIG. 11. is a side view of the multi-purpose unmanned aerial vehicle with the docked module for launching winged bomb or glider drone;

FIG. 12 is a side view of the method of separating a winged bomb or glider drone from a multi-purpose unmanned aerial vehicle.

FIG. 13 is a side view of the winged bomb flight path to the target;

FIG. 14 is a projection view of a multi-purpose unmanned aerial vehicle with a longitudinally rotating module with examples of various types of weapons or devices installed. But their types and number are not limited.

FIG. 15 is a side view of the multi-purpose unmanned aerial vehicle with a longitudinally rotating module with multi-barreled weapons in the position for firing up and down;

FIG. 16 is a top view of the multi-purpose unmanned aerial vehicle with a longitudinally rotating module with multi-barreled weapons in the position for firing up and down;

FIG. 17 is a front view of the multi-purpose unmanned aerial vehicle with a rotating multi-barrel grenade launcher, in this embodiment firing up-right and down-left;

FIG. 18 is a front view of the multi-purpose unmanned aerial vehicle with a rotating module with a multi-barrel rocket launcher firing rockets at the moment of firing to the right-down;

FIG. 19 is a projection view of the multi-purpose unmanned aerial vehicle with a rotating module with a multi-barrel rocket launcher firing rockets at the moment of firing left;

FIG. 20 is a top view of the multi-purpose unmanned aerial vehicle with a rotating module with a multi-barrel rocket launcher turned into position along the longitudinal frame;

FIG. 21 is a side view of the multi-purpose unmanned aerial vehicle with motors and propellers reinstalled in the lower position;

FIG. 22 is a side view of the multi-purpose unmanned aerial vehicle with a module with folded solar power plant;

FIG. 23 is a top view of the multi-purpose unmanned aerial vehicle with a module with a folded fan-type solar panel;

FIG. 24 is a top view of the multi-purpose unmanned aerial vehicle with a module with a fully deployed fan-type solar panel;

FIG. 25 is a side view of the multi-purpose unmanned aerial vehicle with installed module with a fully deployed fan-type solar panel

FIG. 26 is a rear view as another drone lands on a multi-purpose unmanned aerial vehicle with a solar panel to recharge itself via electrical contacts;

FIG. 27 is a rear view as another drone lands on a multi-purpose unmanned aerial vehicle with a solar panel to recharge itself via a contactless plate.

FIG. 28 is a side view of the multi-purpose unmanned aerial vehicle with installed modules for cargo carry;

FIG. 29 is a side view of the second embodiment of the multi-purpose unmanned aerial vehicle with an I-shaped frame 1 in a dual-rotor design, with landing gear;

FIG. 30 is a top view of the second embodiment of the multi-purpose unmanned aerial vehicle with an I-shaped frame in a dual-rotor design. This embodiment of the multi-purpose unmanned aerial vehicle has the same technical design as the first embodiment of the drone with an H-shaped frame.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

The following detailed description of the invention references specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The present invention is defined by the appended claims and the description is, therefore, not to be taken in a limiting sense and shall not limit the scope of equivalents to which such claims are entitled.

The present invention is a multi-purpose unmanned combat drone or flying platform (hereinafter the drone) related to the field of unmanned drones-multicopters.

This application discloses a four- and two-rotor drone platform. A multi-purpose drone can have a different number of rotors, both electric and with internal combustion engines.

The multifunctionality of the drone is achieved due to the design features of the drone-multicopter.

The drone frame has a central longitudinal beam-axis, to which various modules are attached to perform various functions.

A module is a payload or weapon attached to the beam-axis with special locks or fastening methods.

The modules can be tubular, put on and rotate around the central longitudinal beam-axis of the drone frame or be fixedly installed on the beam-axis.

Together with the drone frame, the modules form a single mechanism. Each module performs a specific task. Only one module can be installed on the drone at a time.

The modules are located behind the head, along the longitudinal centerline at the center of gravity of the drone, so the drone has a small cross-section, which has a positive effect on the aerodynamics of the drone in flight.

The drone is equipped with a telemetry system, a video camera for visual review of the flight route by the operator, and at least another video camera for aiming weapons at the target and firing, or for controlling the module in flight.

The modules can be activated using radio signals from the operator to the servos. The drone can also be programmed for a flight mission, or receive signals from a satellite or via an Internet connection.

Due to its design, the drone is capable of firing at 360 degrees and in any direction in space with various jet, self-propelled, recoilless missiles, grenades, shooting from a laser gun, releasing smoke bombs and heat bombs-false targets, bombing with various ammunition, shooting from small arms, from a flamethrower, transporting cargo, illuminating the area with the help of a powerful searchlight module, acting as a mobile solar power station for self-recharging or charging other gadgets in the field. The drone can also have a rotating module-a water cannon and be used to extinguish fires, as well as spray various liquids.

The areas of application of the drone are unlimited and can be constantly updated and supplied with more and more new modules and design. All drone mechanisms, flight controller, control systems, gyroscope, video cameras, batteries, rotors are evenly spaced at both ends of the beam-axis of the frame in order to balance the drone. To ensure interaction between all drone systems, electrical wires and actuators run inside the tubular beam-axis of the frame.

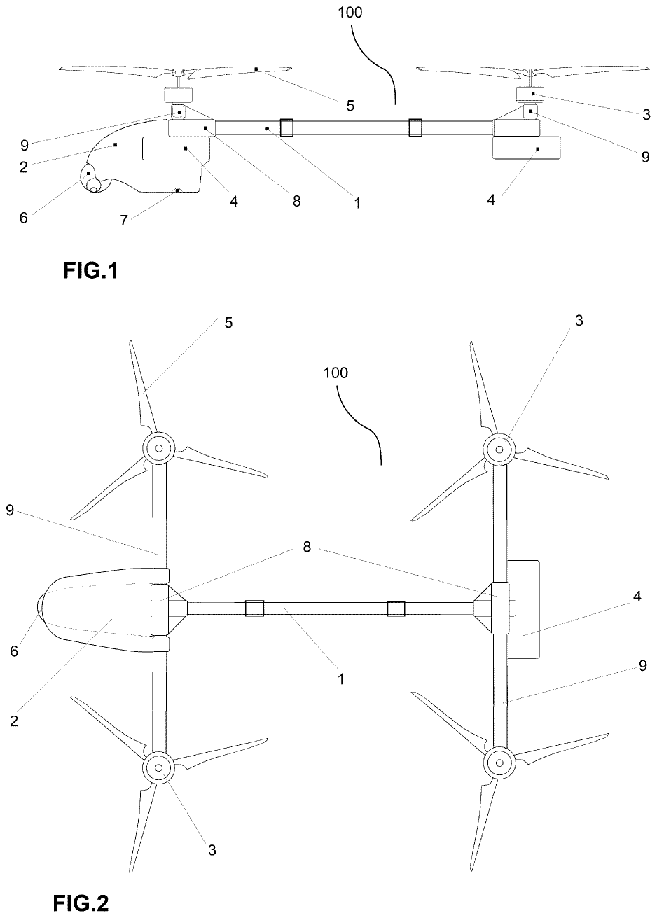

FIG. 1 is a side view of the multi-purpose unmanned aerial combat drone-multicopter 100 without replaceable modules.

The drone 100 has a bearing H-shaped collapsible frame with the longitudinal beam-axis 1 with a head part 2 located on it, inside which there may be an antenna, a telemetry system, a radio receiver, a controller, a flight and fire control system, a battery 4, a thermal imaging camera 6, a laser sight with a rangefinder 7. Angled brackets 8 connect the beam-axis 1 of the frame with four transverse or inclined beams 9, at the ends of which electric motors 3 with propellers 5 are located. This is the empty condition of the drone 100.

The beam-axis 1 of the frame is designed for quick attachment to it and removal of various adapted modules that perform certain functions. The drone operator does this manually, unfastening the module installed on the drone and then installing another module in its place. Replacing modules does not exceed 3-5 minutes.

FIG. 2 is a top view of the drone 100 with the H-shape frame without replaceable modules.

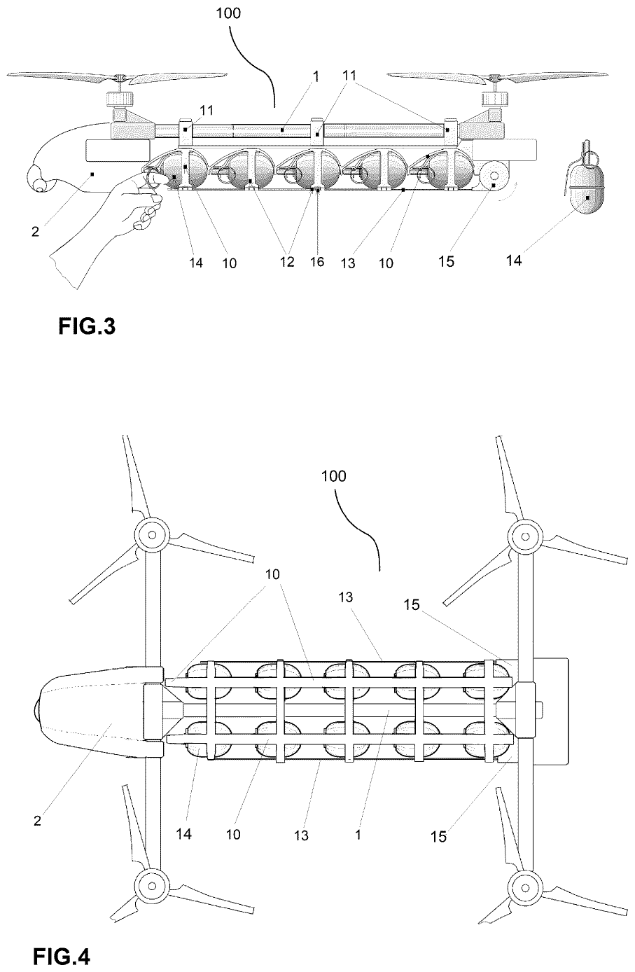

FIG. 3 is a side view of a drone 100 with a module 10 for dropping hand grenades 14. To load, the operator of the drone 100 take the empty module 10 and insert it on top of the beam-axis 1. The module 10 is designed as a longitudinal double-row holder with niches for grenades 14. The number of hand grenades 10 may vary and may be limited only by the drone's carrying capacity or its dimensions. Module 10 is secured to beam-axis 1 of the frame using latches-locks 11.

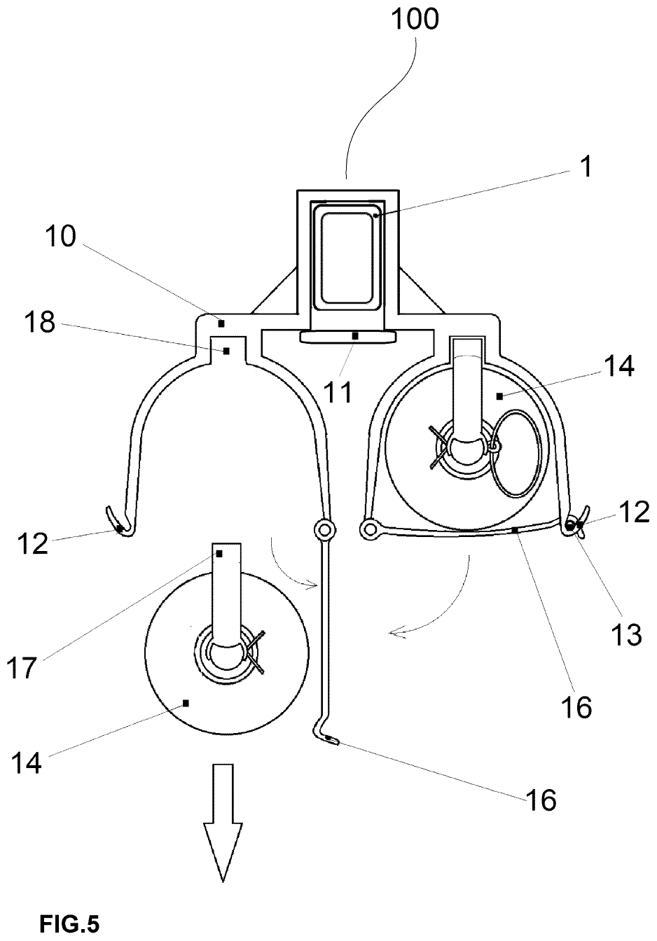

To load a module, the operator places a hand grenade 14 in the niche of module 10 so that the grenade pin enters the groove 18 (FIG. 5), clamps the grenade from below with elastic flap 16, the end of which is aligned with support 12 and passes an activating cable 13 between them, connected to a motor 15 with a winding drum. After loading the module 10 with grenades 14, the operator pulls out the ring of each grenade 14 installed in module 10. Grenade 14, pressed from below by flap 16, is tightly clamped in the niche of module 10. The drone 100 is ready for grenade dropping operation.

To release and drop a grenade 14 in the flight, the operator gives a signal to turn on electric motor 15, it starts to rotate its drum, which winds and pulls out the activating cable 13, and it comes out of the space between an elastic flap 16 and the support 12. As a result, the elastic flap 16 falls down and releases the grenade 14 from the module niche and it falls freely to the ground. The algorithm for pulling out the activating cable 13 is programmed intermittently, so that the grenades are dropped only one at a time, on separate commands from the operator. In this way, the drone 100 bombards with hand grenades 14.

FIG. 4 is a top view of the drone 100 with a hand grenade dropping module 10 installed on it, made in the form of a longitudinal double-row holder.

FIG. 5 is a front sectional view of the docked dropping hand grenades module 10 mounted on the beam-axis 1 of the drone's frame and the operating principle of the mechanism for attaching and dropping grenades 14.

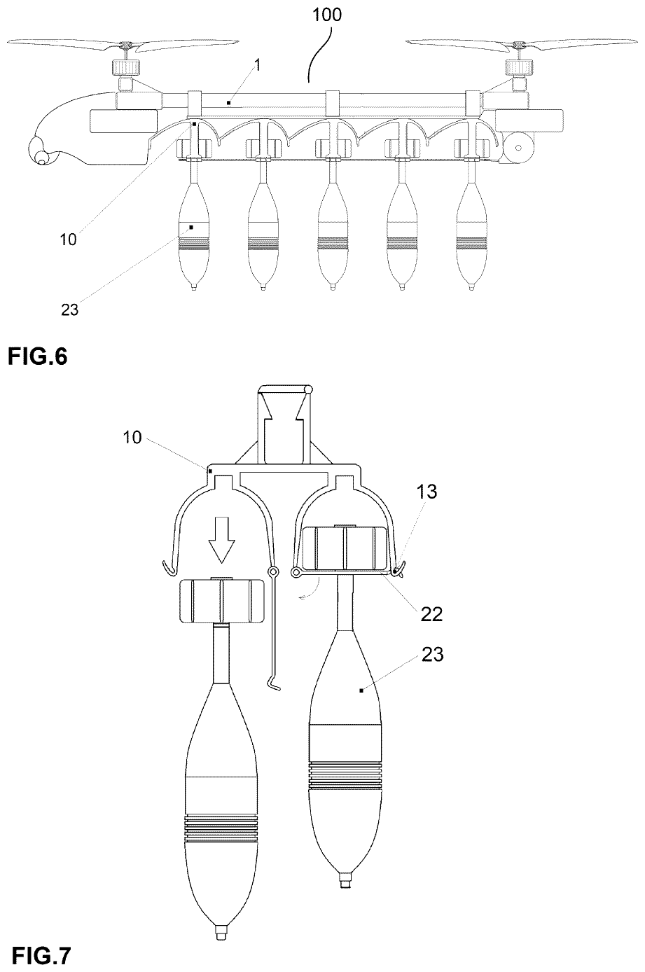

FIG. 6 is a side view and FIG. 7 is a front sectional view of the drone 100 with a docked a mortar mines dropping module 10 installed on the beam-axis 1 of the drone's frame. The principle of its operation is the same as the grenade-dropping module 10 described in FIG. 3. Here, there is also a module 10, an opening flap 22, and instead of a hand grenade, a mortar mine 23 is installed.

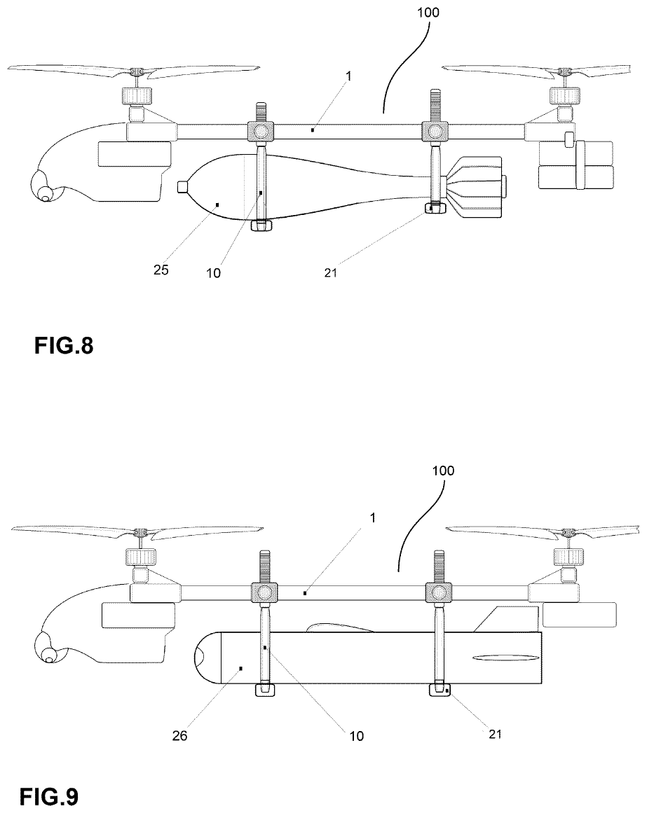

FIG. 8 and FIG. 9 are side views of the drone 100 with a module 10 attached to its beam-axle 1 for holding and dropping munition 25 or a guided missile 26. The release of a munition can be accomplished by activating a servo 21 on command “open” from the operator.

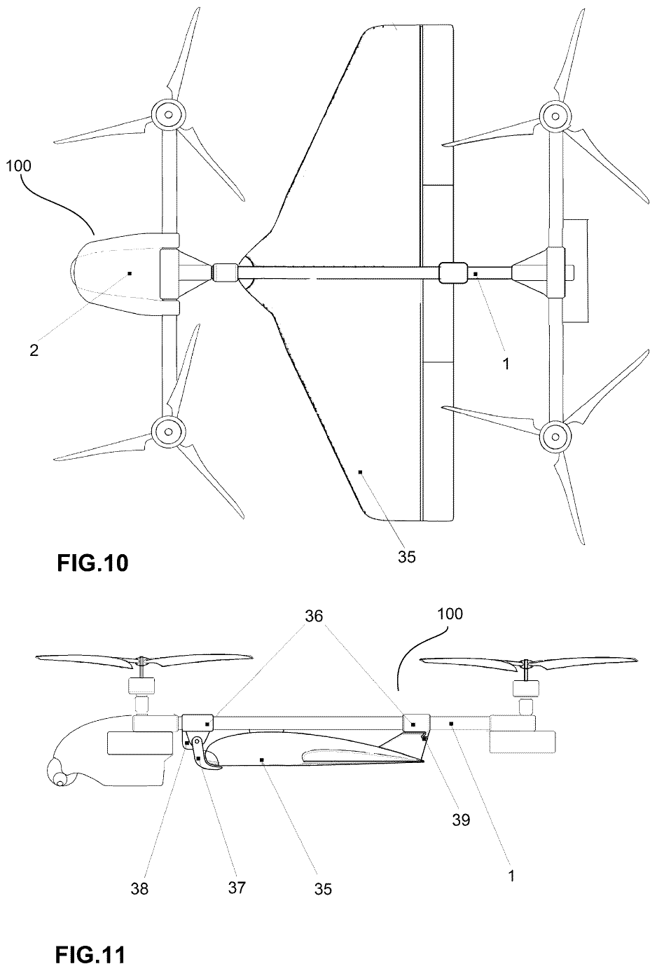

FIG. 10 is a top view and FIG. 11 is a side view of a drone 100 with a detachable wing-shaped bomb 35. Wing-bomb 35 can be secured to the beam-axis 1 of the drone with a latches 36, and a hook 37 is deployed using a servo drive 38. At the rear, a wing-bomb 35 is secured with a hook 39. During flight, a wing-bomb 35 creates additional lift, which increases the range and speed of the drone 100.

When approaching the target, the wing-bomb 35, on command from the operator to a servo drive 38 with hook 37, separates from the drone 100 and, can using its own video camera and a steering mechanism, independently directs itself to the target and hits it. At this time, the drone 100 flies as far away from the target as possible, which increases the likelihood of its survival. Instead of the winged bomb 35, a glider of similar dimensions can be used, which can be equipped with an engine.

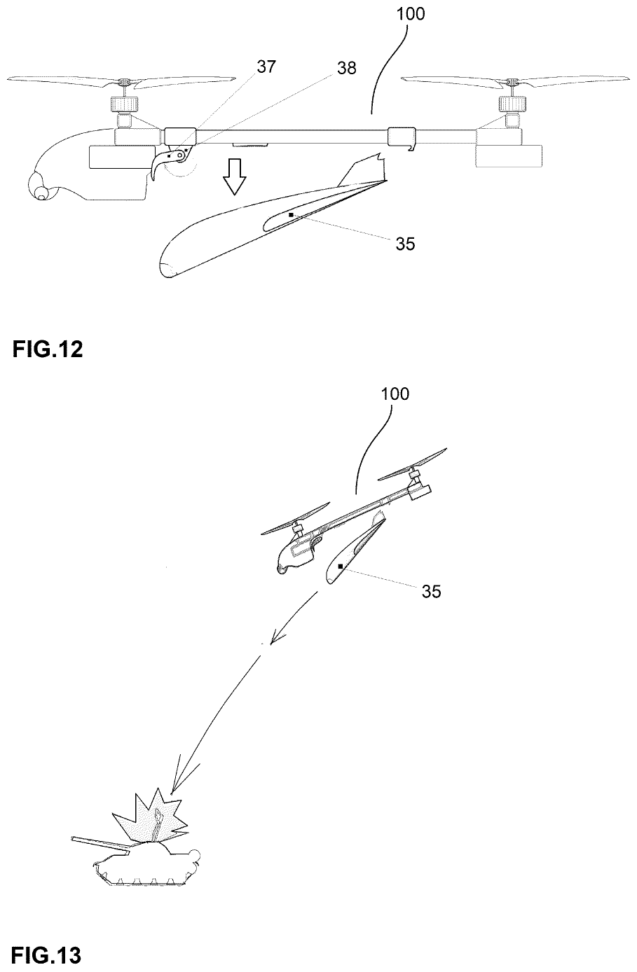

FIG. 12 is a side view of the method of launching a winged bomb 35 or glider from a drone 100.

FIG. 13 is a side view of the winged bomb 35 flight path to the target;

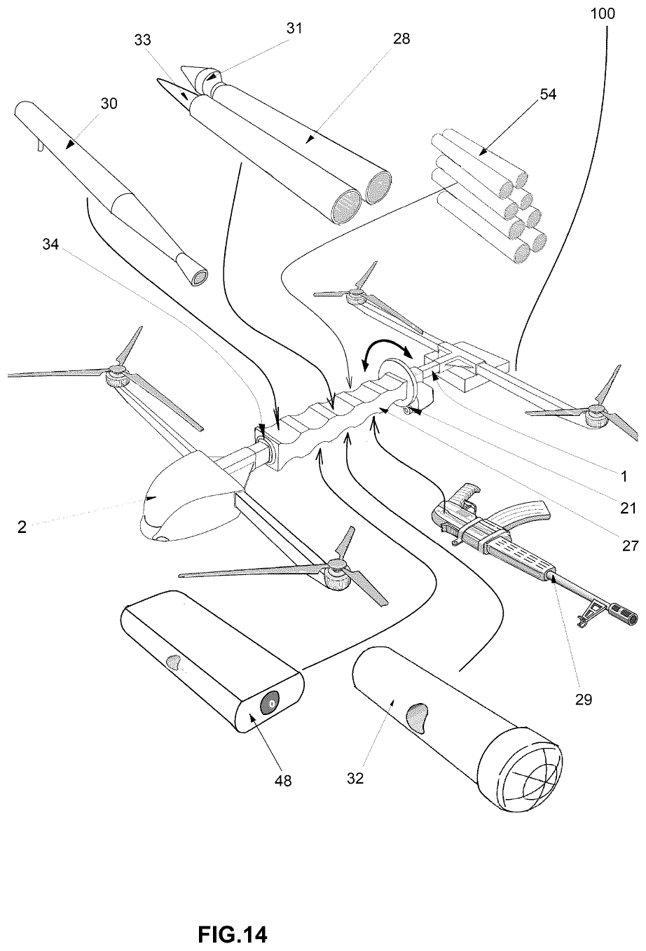

FIG. 14 is a projection view of a drone 100 with a beam-axis 1 and a rotating module 27 mounted thereon. The beam-axis 1 is the axis of rotation for the module 27, on which various types of weapons and devices can be mounted, such as barrels 28 for launching missiles and grenades 31, small arms 29, water cannons or flamethrowers 30, a searchlight for illuminating the area 32, a laser cannon 48, various smoke, illumination bombs and electable false heat targets 54. The number of possible weapons and devices may be unlimited.

A gearbox 21 is provided for rotating module 27. Module 27 rotates on the beam-axis 1 using bearings 34. For example, to fire grenades 31 or rockets 33 installed in the barrels 28 the operator via telemetry system finds a target, turns the drone 100 in the desired direction, then rotates the barrels 28 at the required angle at the target, aims through the video camera and fires. Thanks to rotating module 27, the barrels 28 mounted on it can fire projectiles 360 degrees in space and in any direction. The same method is used to aim or control other types of weapons and equipment that can be installed on rotating module 27.

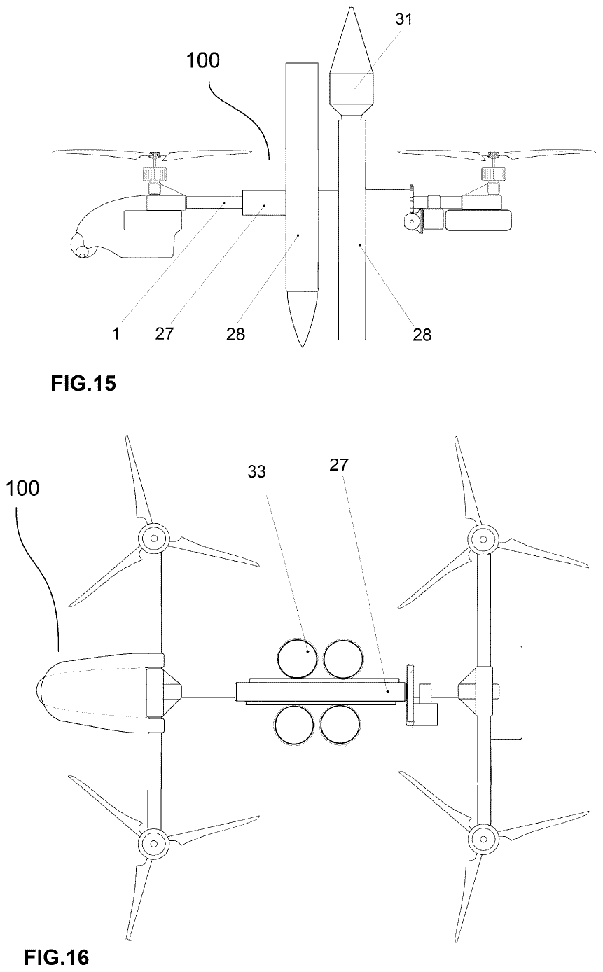

FIG. 15 is a side view of the drone 100 in the position of the rotating module 27 with barrels 28 for firing grenades 31 or missiles 33 vertically up and down.

FIG. 16 is a top view of the drone 100 in the position of the module 27 with barrels 28 for firing grenades 31 or missiles 33 vertically up and down.

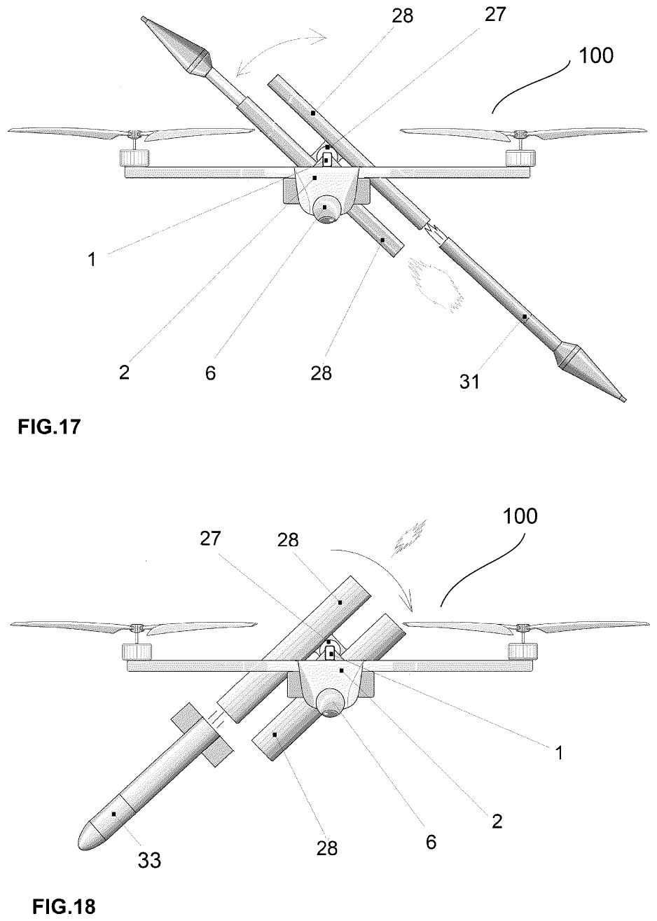

FIG. 17 is a front view of a drone 100 having a head section 2 containing flight equipment with a video camera 6, and on the beam-axis 1 of the drone frame, a rotating module 27 with a multi-barrel grenade launcher 28 is mounted, in this example firing up-right or down-left.

FIG. 18 is a front view of a drone 100 having a head section 2 containing flight equipment with a video camera 6, and on the beam-axis 1 a rotating module 27 with a multi-barrel rocket launcher 28 firing rockets 33 at the moment of firing to the right-down.

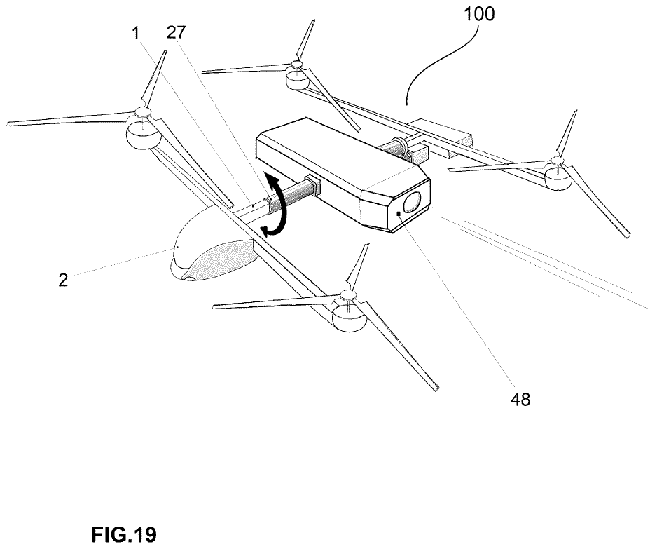

FIG. 19 is a projection view of a drone 100 having a head part 2 with a video camera 6, a beam-axis 1 with a rotary module 27 mounted on it, on which a laser cannon 48 is fixed. An operating method for firing with laser cannon according its instruction for regular using.

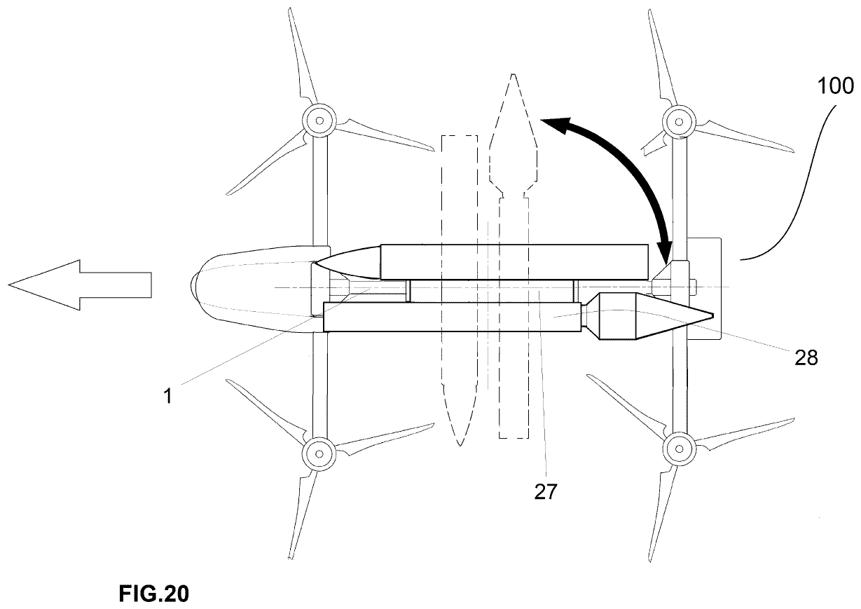

FIG. 20 is a top view of the transport position of the drone 100 with a rotating module 27 containing a multi-barrel rocket launcher 28 deployed in a position along the longitudinal beam-axis 1 of the drone's frame to reduce the frontal drag of the drone 100 and fire forward. The arrow shows the direction of flight of the drone 100.

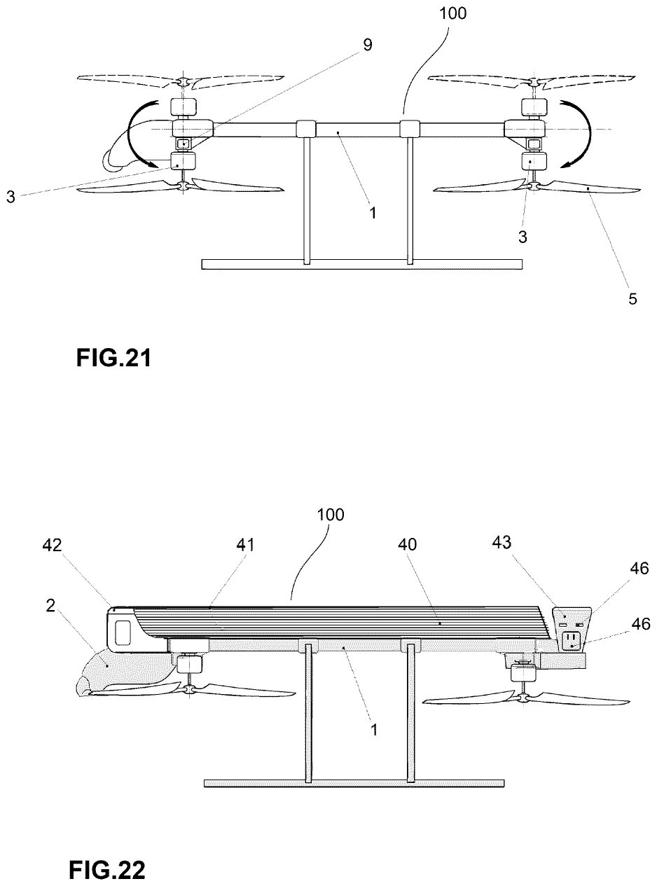

FIG. 21 is a side view of the drone 100 with a motors 3 and propellers 5 reinstalled in the lower position. The method of installing motors 3 on beams 9 can be either on top of the beams 9 or below, as shown in this figure. The lower motor mount is used to free up the upper space above the drone 100 frame to install the next module on it, which is called a solar power plant. It is attached to the top of the drone frame beam-axis 1. The operator carries out such preparatory work before placing the solar power plant module on the drone 100.

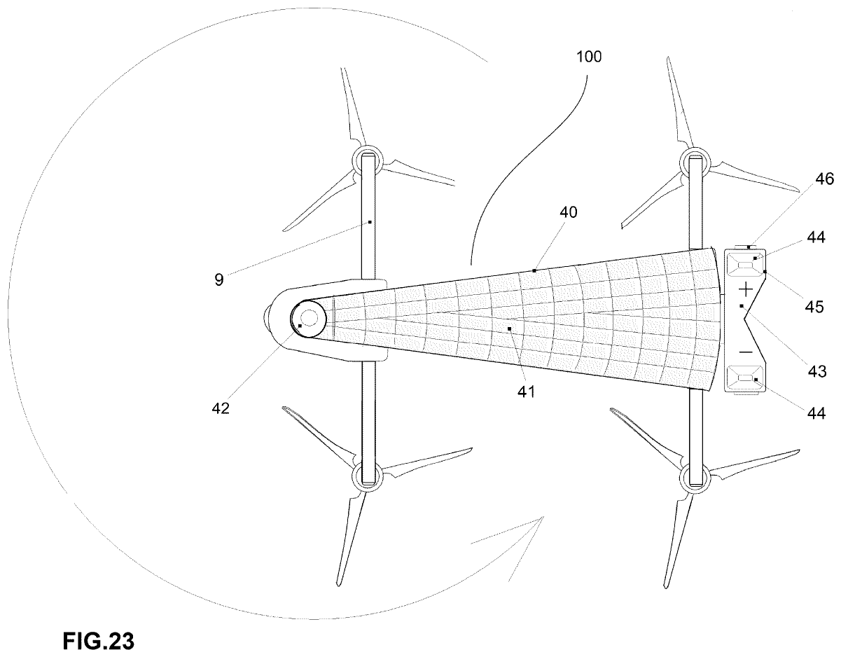

FIG. 22 is a side view of a drone 100 with a module called a folding solar power plant 40. The folding solar power plant 40 can consists of several fan-shaped petal panels 41, which in the folded position are located longitudinally along the drone beam-axis 1. The solar power plant 40 has a drive motor 42 for opening the petal panels 41. After the drone lands, at the command of the operator or according to a programmed mode, the drive motor 42 is turned on and the petal panels 41 begin to open in a circle, forming a round solar panel station 40. A solar power plant 40 begins to charge the drone batteries. At the rear of the solar power plant 40 frame, there may be a block-converter 43 with a landing pad 45 (FIG. 23) for other drones and sockets 46 for recharging other gadgets in the field. Block-converter 43 with a pad may have electrical contacts 44 for transmitting electricity to another drone, or recharging them in a contactless manner.

FIG. 23 is a top view of a drone 100 with a module called a solar power station 40, which consists of petal panels 41 assembled in a stack along the longitudinal central axis of the drone 100 via a motor 42, a block-converter 43 with a landing pad 45 for contactless recharging of other drones, and may also have a contacts 44 and a sockets 46 for recharging other drones and a gadgets. Other drones with an adapter for recharging can land on the block-converter 43 with the platform 45 and recharge contactlessly, or through contacts 44. Having charged their batteries, the other drone can take off and continue flying.

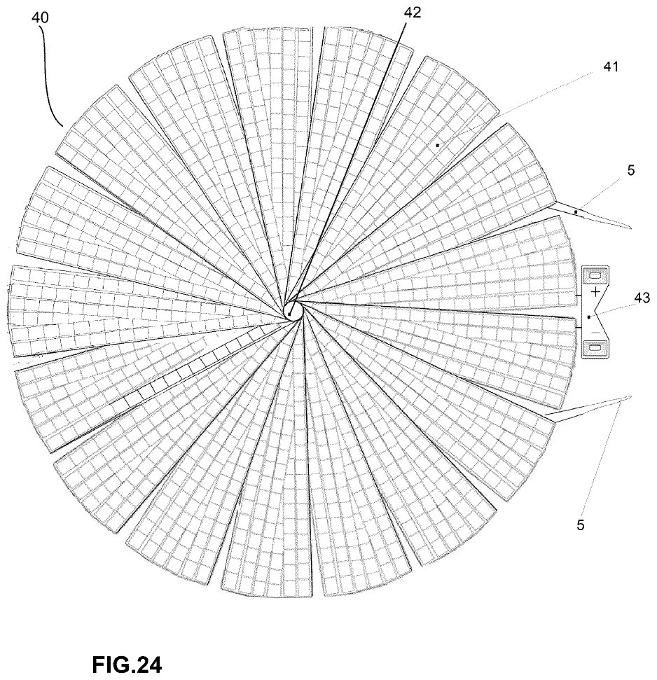

FIG. 24 shows a top view of a fully deployed fan-shaped solar plant 40, which consists of petal panels 41, a drive motor 42 for deploying the petal panels, block-converter 43 and propellers 5.

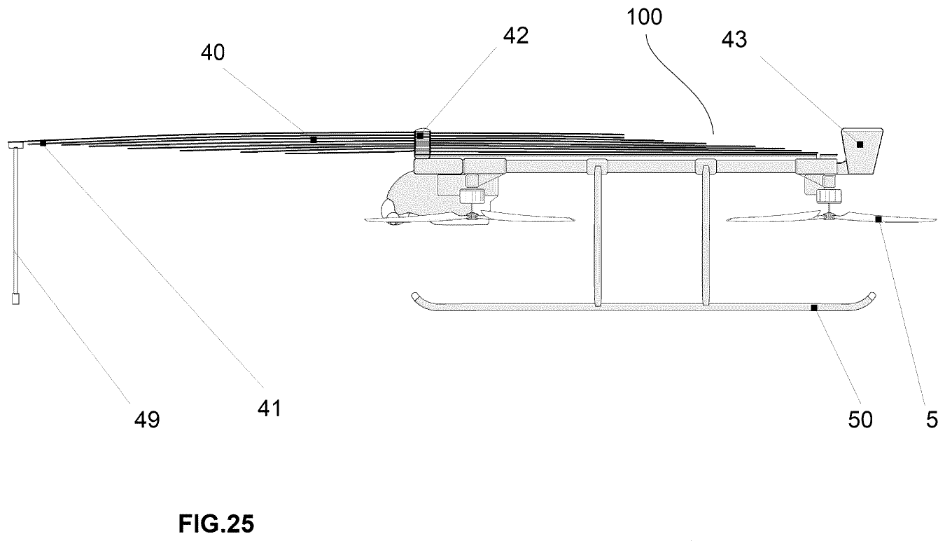

FIG. 25 is side view of the drone 100 with an installed module with a fully opened fan-shaped solar plant 40, a drive motor 42, a block-converter 43 for recharging other drones and gadgets, propellers 5 in the lower position and a landing gear 50. The solar power station can be equipped with an additional self-extending leg 49 for the stability of petal panels 41 during land position.

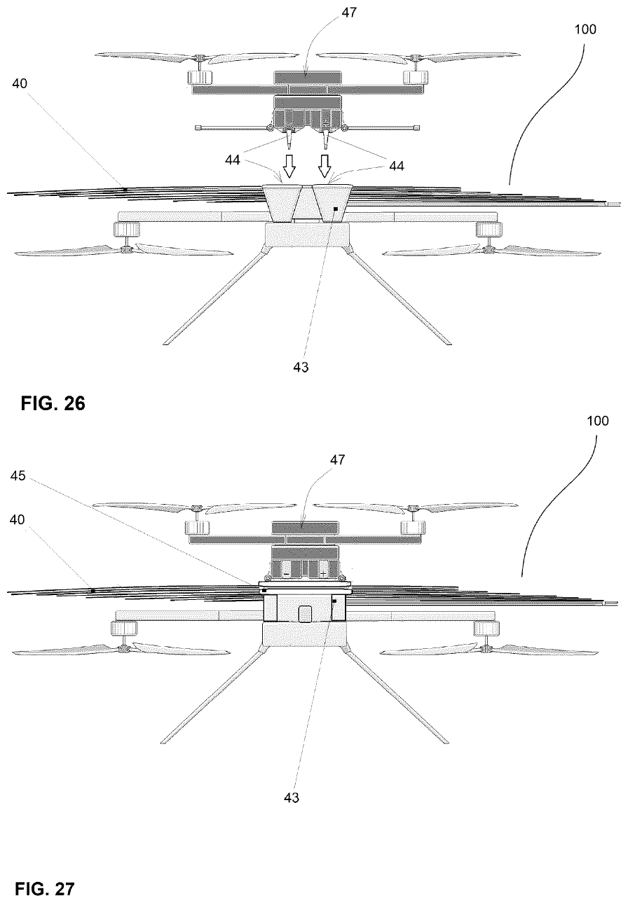

FIG. 26 is a rear view as another drone 47 lands on a drone 100 with a solar panel 40 in order to recharge itself via electrical contacts 44 located on the block-converter 43.

FIG. 27 is a rear view of the drone 100 when another drone 47 has landed on the drone 100 with the solar plant 40 and is charging through the contactless plate 45 of the block-converter 43.

After self-charging or charging other consumers, the drone 100, on command from the operator or in a programmed mode, folds its petals-panels 41 into the transport position and flies away along a given route.

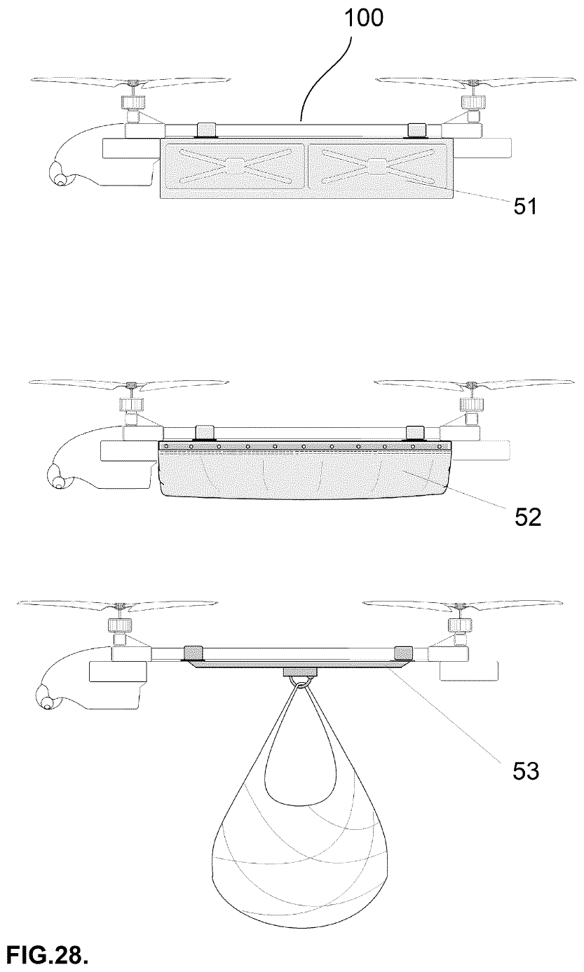

FIG. 28 is a side view of a drone 100 with docked cargo modules for transporting cargo. The cargo modules can be rigid 51, or soft 52, or suspended 53. The operator manually places these cargo modules on the empty beam-axis 1, fills them with the required cargo and pilots them remotely or sends the drone to the specified delivery location.

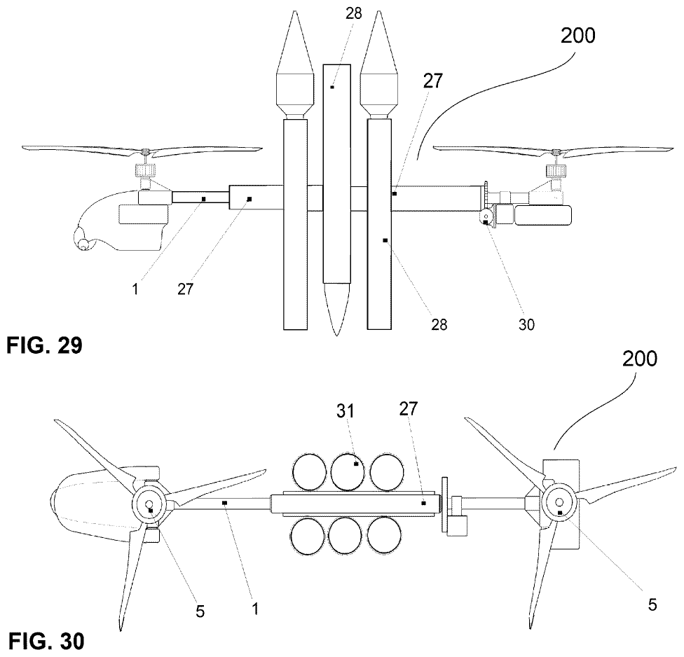

FIG. 29 is a side view of the second embodiment of the drone 200 with the I-shaped frame 1 and a dual-rotor 5 design. The frame 1 is also an axis for rotation and installation of various modules, as in the first version of the drone 100 with an H-shaped frame. In this version, there are no cross beams 9.

FIG. 30 is a top view of the second version of the drone 100 with the I-shaped frame 1 in a dual-motor 5 design. This version of the drone has the same technical design as the first version of the drone 100 with an H-shaped frame.

FIG. 29 is a side view of the second embodiment of the drone 200, but with the I-shaped frame 1 and a dual-rotor 5 design. The frame 1 is also an axis for installation of various rotating or fixed modules, as in the first embodiment of the drone 100 with an H-shaped frame. In this version, there are no cross beams 9.

FIG. 30 is a top view of the second embodiment of the drone 200 with the I-shaped frame 1 in a dual-rotor 5 design. This drone has the similar technical design of the docking modules, control methods and operation principles of the systems as on the first embodiment of the drone 100 with an H-shaped frame.

1. The multi-purpose unmanned combat drone comprising:
a) the H-shaped collapsible tubular frame with a central longitudinal beam-axis, onto which the removable rotating or fixed modules carrying a weapons or equipment or payload are installed alternately;
b) the four frame beams located transversely or at an angle to the central beam-axis and the four rotors or more located on these beams;
c) the head section including a flight equipment and a battery located at one end of the central longitudinal beam-axis and the tail section with an additional equipment and a battery located at the opposite end of the central longitudinal beam-axis of the frame.

2. The multi-purpose unmanned combat drone according to claim 1, wherein the removable rotating tubular module installed via the bearings in the center of the beam-axis of the frame, capable of rotating around it by 360 degrees using its own motor and designed to carry and rotate the launchers for firing with:
a) the rockets and grenades;
b) the small arms;
c) the laser cannon;
d) smoke, heat grenades-false targets;
e) a flamethrower;
f) a water cannon or liquid sprayer;
g) carrying a floodlight,
and controlled by the operator with signals transmitted to the module rotation motor and to the trigger devices of weapons or equipment via servo drives remotely via a telemetry system or via satellite or Internet communication, as well as according to a programmed mode.

3. The multi-purpose unmanned combat drone according to claim 1, wherein the removable module, one or more, is mounted fixedly on the central beam-axis of the frame and is designed to carry and drop:
a) the bombs, mines, grenades;
b) a cruise missile;
c) the gliders and aircraft with an engine;
d) the modules for transporting cargo,
and controlled by the operator using signals transmitted to the servo drives of the launch devices of the weapons or an equipment remotely via a telemetry system or via satellite or Internet communication, as well as in a programmed mode.

4. The multi-purpose unmanned combat drone according to item 1, wherein the fixed module is installed on the beam-axis of the frame—the solar electric power plant with the folding petal solar panels, the drive motor for opening and folding the panels, the block-converter for charging other drones and a consumers by the contact and contactless methods and controlled by an operator using the signals transmitted remotely via a telemetry system or via the satellite or Internet communication, as well as in a programmed mode.

5. The multi-purpose unmanned combat drone according to item 3, wherein the module installed on the central beam-axis of the frame is designed to carry and release an ammunition, having a release mechanism consisting of the motor with the drum and the cable, which, when wound on the drum, opens the locking device and releases the hand grenade or mine or bomb, which falls down in free fall on command of the operator remotely through a telemetry system, satellite or Internet communication, as well as according to a programmed mode.

6. The multi-purpose unmanned combat drone, including an I-shaped tubular frame, which is a rigid supporting beam-axis, in the center of which the removable module with a motor rotating around the beam-axis, or a fixed module, which carry weapons or equipment, according to items 2 and 3, are attached and a head section with flight equipment and batteries, located at the front end of the central longitudinal beam-axle and a tail section with additional equipment and batteries, located at the rear end of the central longitudinal beam-axle; two rotors, located at the front and rear ends of the beam-axle.
